(19) United States
(12) Patent Application Publication
(10) Pub. No.: US 2016/0353487 A1
(43) Pub. Date: Dec. 1, 2016

(54) Mobile Phone Capable of Broadcasting Videos or Pictures

(71) Applicant: Kuo-Ching Chiang, New Taipei City (TW)

(72) Inventor: Kuo-Ching Chiang, New Taipei City (TW)

(21) Appl. No.: 15/231,798

(22) Filed: Aug. 9, 2016

Related U.S. Application Data
(62) Division of application No. 14/272,479, filed on May 7, 2014.
Application No. 14/272,479 is a continuation-in-part of application No. 11/724,262, filed on Mar. 15, 2007, now abandoned.
Application No. 11/724,262 is a continuation-in-part of application No. 11/011,465, filed on Dec. 13, 2004, now abandoned.

(51) Int. Cl. H04W 76/00; H04W 4/00; H04N 1/00; H04N 21/61; H04N 21/4223; H04N 21/2743; H04N 21/4627; H04W 12/04; H04N 21/414

(52) U.S. Cl. CPC H04W 76/002; H04W 12/04; H04W 4/008; H04N 1/00204; H04N 1/00339; H04N 21/41407; H04N 21/4223; H04N 21/2743; H04N 21/4627; H04N 21/6175; H04N 2201/0055

(57) ABSTRACT

The present invention provides a mobile phone, including: a control unit; a display coupled to the control unit; a memory coupled to the control unit, wherein the memory stores at least one video or picture; a wireless broadcasting device configured to share the at least one video or picture; and a group broadcast application configured with the wireless broadcasting device to broadcast the at least one video or picture to at least two another mobile phone, wherein a group key is required for the group broadcast application, the wireless broadcasting device broadcasting the at least one video or picture on the display to the at least two another mobile phone.

### CROSS REFERENCE TO RELATED APPLICATIONS

The application is a division application of U.S. application Ser. No. 14/272,479, filed on May 7, 2014 which is a continuation-in-part application of U.S. application Ser. No. 11/724,262, filed on Mar. 15, 2007, which is a continuation-in-part application of U.S. application Ser. No. 11/011,465, filed on Dec. 13, 2004, Applicant hereby claim the priority right in the entirety of the applications mentioned above.

### TECHNICAL FIELD

The present invention relates generally to a mobile phone, and particularly to a mobile phone capable of broadcasting videos or pictures.

### BACKGROUND OF RELATED ARTS

Digital cameras have become available. These cameras normally rely upon the utilization of a charged coupled device (CCD) or CMOS sensor to sense an image. The camera normally includes storage media for the storage of the sensed scenes in addition to a connector for the transfer of images to a computer device for subsequent manipulation and printing out. The photodiode in the image sensor generates electric charges using absorbed light, converts the generated electric charges into an analog current. The read-out circuit converts the analog signal into a digital signal and outputs the signal.

A problem arisen from the digital camera is that the captured image can be displayed on the camera only. It cannot be viewed in another device unless output the image via cable to the computer. It is inconvenient to the consumer.

It would therefore be desirable to provide a method for sharing the image captured by the digital camera or smart phone.

### SUMMARY

The present invention provides many additional advantages which shall become apparent as described below.

The object of the present invention is to provide a mobile phone which can broadcast videos or pictures.

The object of the present invention is to provide a mobile phone, including: a control unit; a display coupled to the control unit; a memory coupled to the control unit, wherein the memory stores at least one video or picture; a wireless broadcasting device configured to share the at least one video or picture; and a group broadcast application configured with the wireless broadcasting device to broadcast the at least one video or picture to at least two another mobile phone, wherein a group key is required for the group broadcast application, the wireless broadcasting device broadcasting the at least one video or picture on the display to the at least two another mobile phone.

The memory may include FLASH memory, and the wireless broadcasting device may include WiFi module, WiMax module, Bluetooth module or RF module. The memory may include a hybrid memory module. The memory may include a sharing mode.

### BRIEF DESCRIPTION OF THE DRAWINGS

FIG. 1A shows a function diagram according to the present invention.

FIG. 1B shows a function diagram according to the present invention.

FIG. 1C(a) and FIG. 1C(b) show the wireless memory according to one embodiment of the present invention.

FIG. 1C(c) shows the hybrid non-volatile memory according to one embodiment of the present invention.

### DETAILED DESCRIPTION

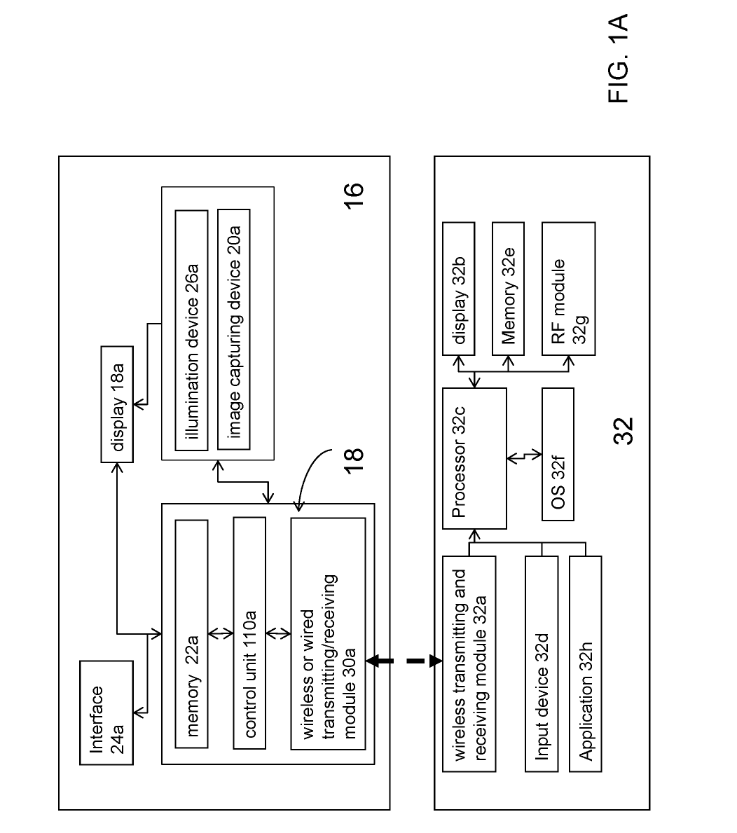

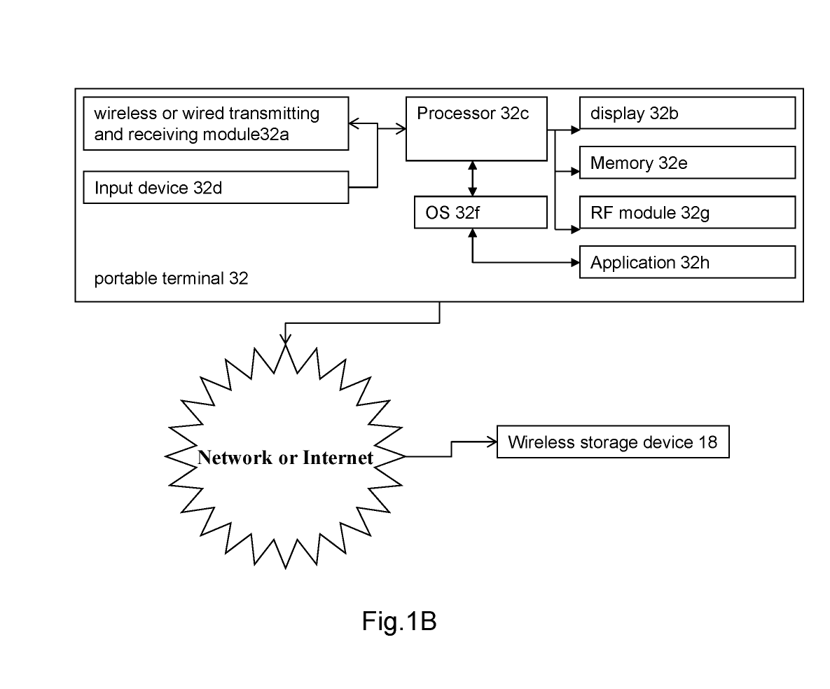

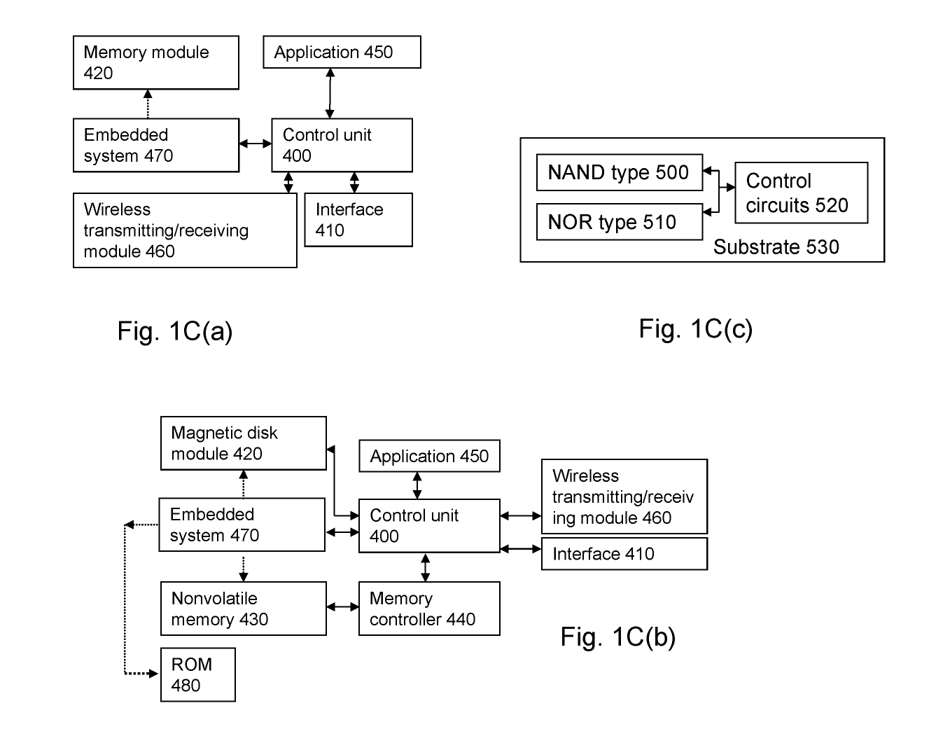

The following description is provided to enable any person skilled in the art to make and use the invention. Various modifications, however, will remain readily apparent to those skilled in the art, since the generic principles of the present invention have been defined herein specifically to provide an overall method and devices for a food storage tracking system. FIGS. 1A and 1B show an illustration and a block diagram of the present invention. Almost of the elements and description of Please refer to FIGS. 1A and 1B, a memory 22a is provided with an embedded wireless transmitting/receiving module 30a and a control unit 110a is coupled to the memory 22a with the wireless transmitting/receiving module 30a to process the command, signal and instruction from the user. A display panel 18a is equipped and coupled to the control unit 110a. The wireless memory 18 includes the memory 22a, the control unit 110a and the wireless transmitting/receiving module 30a, it may refer to wireless storage device or wireless memory. One or more image capturing device 20a is set and the image capturing device and illumination device can be incorporated in a case 16 of a portable device with the image capturing device 20a. The image capturing device 20a is electrically (or optically) coupled to the display panel 18a, control circuits 110a. The image capturing device 20a is set in the case 16. An illumination device 26a is set to provide the illumination for the image capturing device 20a when the environment is dark for the image capturing device 20a takes an image or shooting. The image capturing device 20a and the illumination device 26a could be built-in together. The image capturing device 20a could capture the image, therefore, the image of the items could be taken or shot by the image capturing device 20a. The image capturing device 20a could be, for example, CCD, or CMOS sensor. The illumination device 26a could be LED, IR ray source or the like. When the image capturing device 20a is on, the image can be captured and send it to the display panel 18a, thereby displaying captured image in the form of video or picture on the display 18a. In one embodiment, a LCD screen is provided for the display panel to display. Other type display could also be used such as plasma display panel, LED display panel, FED display panel, EL panel, OEL and OLED panel. A low-power CMOS (complementary metal oxide semiconductor) microprocessor with integral FLASH maybe employed. A molded plastic case for the screen encloses the circuit board. Power is provided by wired power source or batteries. The image capturing device 20a includes a charged coupled device (referred to as “CCD”) or CMOS. Further, the image capturing device 20a has the zoom-in and zoom-out functions controlled by the user. Memory 22a refers to nonvolatile memory or magnetic storage device, for example hard disk. The memory 22a is coupled to the image capturing device 20a for storing a captured data such as single frame image or video data, wires are used to connect the control circuits 110a, power source and the display 18a. The memory could be FLASH. Corresponding driving circuits may be incorporated into or separated from the control circuits 110a. The flash memory could be replaced by other NVM (non-volatile memory) such as NROM (nitride-ROM), SONOS or MRAM, FRAM. An interface 24a coupled to the control circuits 110a may be provided to the wireless storage device 18 for transferring data. The wireless transmission/receiving module 30a can perform such function as well. Under the architecture, the wireless storage device 18 may refer to a wireless Flash memory card or drive. The wireless storage device 18 can act as the separated data storage for other device such as computer, notebook, tablet, mobile phone, digital camera, PDA, medium player. The wireless Flash card may be separable from the portable device. Please be noted that the wireless storage device 18 may be inserted into the computer, notebook, tablet, mobile phone, digital camera, PDA, medium player. The image capturing device 20a is available to catch image of an object. Another embodiment of the present invention further includes a wireless or wired transmission/receiving module 30a coupled to the image capturing device 20a and the control circuit 110a. The wireless or wired transmission/receiving module 30a could be set adjacent to the display panel 18a. It should be noted, it is not the only way to set the wireless or wired transmission/receiving module. The transmission/receiving module could be the wireless transmission/receiving module that is compatible with blue-tooth, 802.11, WiFi, WiMAX standard. The transmission domain (the air) by nature is not secured and therefore pair-wise matching maybe necessary in the wireless transport networks. In one embodiment, pair-wise (encryption/decryption) procedure between every neighboring wireless network device of a wireless transport network is needed. A data frame that leaves from one wireless device from one end of a wireless transport network to the other end of the same network might need several encryptions and decryptions before it reaches its final destination. Furthermore, a group key for a broadcast or a multicast data frame maybe needed in addition to pair-wise encryption keys. An AP may be needed for WiFi device to couple to the internet network. In a preferred embodiment, take the RF module as an example, as known in the art, the RF (wireless transmission/receiving) module includes an antenna connected to a transceiver which is used to receive and transmit signal. As know, the RF module may further include, base band processing unit, DSP and A/D converter. Due to the RF module is not the feature of the present invention, therefore, the detailed description is omitted. The captured image can be transmitted through the RF module 30 by operation frequency while the image capturing device is in function. The RF module could be compatible with 3G or 4G standard. The captured result can be send to a another user terminal 32 with a wireless transceiver (wireless transmitting and receiving module) 32a and a display screen 32b, thereby allowing the user to share the image. The user terminal 32 could be, such as computer system, portable device (cellular), PDA, notebook, smart phone or TV set. The signal could be transmitted or received through wireless transmission. In another case, the transmission is achieved through WiMAX network or WiFi. The instruction is sent via the wired network or wireless network through WLAN. If the WiFi is used, the data maybe transferred through wireless.

If the user terminal 32 includes a cellular, a further RF module 32g maybe incorporated into the terminal 32 for transmitting and receiving communication data. The signal is transmitted from a user terminal 32 to the image capturing device through the mobile phone network by RF module 32g or the transmission/receiving module 32a. It could be transmitted by a 3G or higher level protocol or standard. Alternatively, it could be transmitted by wireless transmitting and receiving module with WiFi, WiMAX, 902.11 or Bluetooth specification. The control circuit 110a will sent the captured image to the user another terminal 32 through the wireless transmitting and receiving module 30a and received by the wireless transmitting and receiving module 32a, as shown in FIG. 1A. Alternatively, the present invention may access the data or captured data stored in the memory 22a from the remote terminal. The user terminal 32 such as mobile phone, may sent a signal to the device through wireless transmitting and receiving module 32a and received by the wireless transmitting and receiving module 30a, followed by sending the signal to the control circuits 110a. The control circuits 110a may fetch the required data stored in the memory 22a and send the required data to the remote terminal 32 wirelessly.

If there are pluralities of device under control, the user may remote control each device as shown in FIG. 1B. The connection manager coordinates communication between WiMAX or WiFi wireless communication protocol and facilitate communication over the wireless communication network. An application is able to coordinate and establish a communication path over WiMAX wireless network for purposes of transferring data. In order to access the data from a remote distance, it prefers that the storage device can be accessed wireless or the data stored therein can be transferred wireless from a remote terminal. Thus, the present invention provides a wireless storage device such as hard disk or flash drive as shown in FIG. 1C(a), the wireless storage 18 scheme can be referred to FIG. 1A. The wireless hard disk drive or flash drive can be accessed by wireless control from separated device. The wireless transmitting/receiving module 460 maybe coupled to the control unit for wireless data transfer. Preferably, share mode application 450 coupled to the control unit 400 is required to achieve the purpose. The application 450 maybe software, hardware or firmware used to share the information through air. In one case, it may be a sharing module or program. The cross-platform file and print sharing made easy, it is a sharing module. The application is a solution for sharing between the different devices or platforms, with bi-directional, allowing device to browse file in the wireless storage device through air, as well as share your images for others to access. Optionally, the present invention also provides a hard disk drive having a Flash memory, as shown in FIG. 1C(b) to have the benefits of both. The hard disk drive includes a control unit 400 coupled to an interface 410 and a magnetic disk module having spindle driver 420, reading/writing head mechanism and so on. This is well-known in the art, the description is omitted. A flash controller 440 is coupled to the control unit 400 and a nonvolatile memory 430 is coupled to the flash controller 440. An application 450 is coupled to the control unit to execute the instruction. A wireless transmitting/receiving module 460 maybe coupled to the control unit for wireless data transfer. The wireless hard drive incorporates the flash memory into the device to yield the benefit of high-speed access and low power consumption. The hard disk drive maybe incorporated into portable media player, cellular, notebook or PDA. A controller 440 is connected to the flash memory 430 to operate the mode under instruction or command. The operation mode includes read mode, write mode, erase mode, and programming mode. The controller 430 is capable to process the USB protocol if the interface includes USB interface. Further, the controller 440 maybe integrated into the control unit 400 under the knowledge and technology of integrated circuits. An embedded system 470 is optionally stored in the erasable/programmable storage medium (flash, ROM or hard disk). It could be OS, simplified OS, an application, software or a list of computer-executable instructions. The embedded system 470 is preferably in a ROM (read only memory) 480 and is another individual memory array separated from the Flash array and coupled to the control unit 400. Alternatively, the ROM 480 may be embedded in the control unit. The data coded in the ROM will not be erased by the user. The embedded system 470 could be provided for a computer or device to execute predetermined function such as operating some application, booting the device, auto backup or auto-run file. In general, after a device is power on, basic input/output system will perform a boot sequence before invoking the OS. Basic input/output system is set in the ROM. During the procedure, the BIOS will detect the priority of the boot up application. The user may set the BISO so as to let the device is boot up by an application stored in a floppy, CD-ROM, DVD drive or other I/O port coupled with a periphery device. In one application of the present invention, we may set the system to be booted by the USB port coupled with the USB drive cording to the present invention. The module could act as “key” for the device. The programmer or instruction can be set in the embedded system to determine what type of data will be stored into what type of storage (flash or hard disk). It could be used for different type of volatile memory having NOR type and NAND type. In one embodiment, the embedded system 470 is OS or simplified OS. The embedded system is coupled to the control unit to determine or assign the duty of the magnetic disk module 420 and the nonvolatile memory 430. The flash benefits high speed performance, low power consumption while hard disk drive yields lower cost. The storage architecture refers to Complementary Storage Device (CSD). The CSD has the benefits of the both type of memory. The manufacture may reduce the cost and increase the performance by incorporating the two kind of memory with an optimized memory ratio between the flash memory and the magnetic memory. The composition of the CDS may follow the following rules to achieve the purpose and the memory ratio maybe fall within the range list below. The calculated method is not the concern of the present invention, the present invention try to predict the ratio range.

Please refer to FIG. 1C(c), the present invention may apply to semiconductor non-volatile memories comprising an array of non-volatile memory cells arranged in a plurality of rows and columns can be characterized as operating either in a NAND mode of operation or a NOR mode of operation. Typically, NAND memory cells are programmed or read to operate in a page mode manner in which a page of data (typically 512 bytes) is stored in a plurality of page buffers that are integrated with the memory circuit device. During programming, a page of data is externally supplied to the NAND device and is stored in the page buffer. From the page buffer, the data is then stored in the NAND cells. In contrast, in a NOR mode of operation, different bytes within the NOR array can be randomly accessed, read or programmed. The difference between the two types is that NOR operation is for random access read or program of a small amount of data faster compared to a NAND program or read operation. NAND operation of program or read is faster than compared to a NOR mode of operation. Conventional flash EEPROM semiconductor memory devices are implemented as either a NOR array or a NAND array. However, a NAND array can advantageously use the tunneling mechanism for both erasing and programming. This provides a much faster erasure than NOR arrays. Thus, while access times are faster in a NOR array, NOR arrays are typically dedicated to applications which require minimal erasure and programming. NAND arrays are suited for storing non-boot code used for data/file manipulation. A storage device comprises a substrate 530; control circuits 520 formed on the substrate 530 to control the reading, writing and erasing of memory cells of the storage device; and a nonvolatile memory array formed on the substrate 530 including NAND type memory array 500 and a NOR type memory array 510 coupled to the control circuits.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

I claim:

1. A mobile phone, comprising:
a control unit;
a display coupled to said control unit;
a memory coupled to said control unit, wherein said memory stores at least one video or picture;
a wireless broadcasting device configured to share said at least one video or picture; and
a group broadcast application configured with said wireless broadcasting device to broadcast said at least one video or picture to at least two another mobile phone, wherein a group key is required for said group broadcast application, said wireless broadcasting device broadcasting said at least one video or picture on said display to said at least two another mobile phone.

2. The mobile phone of claim 1, wherein said wireless broadcasting device includes WiFi device.

3. The mobile phone of claim 1, wherein said wireless broadcasting device includes bluetooth device.

4. The mobile phone of claim 1, wherein said wireless broadcasting device includes WiMax module.

5. The mobile phone of claim 1, wherein said wireless broadcasting device includes RF module.

6. The mobile phone of claim 1, wherein said memory includes FLASH memory.

7. The mobile phone of claim 1, wherein said memory includes hybrid memory module.

8. The mobile phone of claim 7, wherein said memory includes NAND and NOR memory.

9. The mobile phone of claim 1, wherein said memory includes a sharing mode.

10. A mobile phone, comprising:
a control unit;
a display coupled to said control unit;
a memory coupled to said control unit, wherein said memory stores at least one video or picture;
a wifi device configured to broadcast said at least one video or picture; and
a group broadcast application configured with said wifi device to broadcast said at least one video or picture to at least two another mobile phone, wherein a group key is required for said group broadcast application, said wifi device broadcasting said at least one video or picture on said display to said at least two another mobile phone.

11. The mobile phone of claim 10, wherein said memory includes FLASH memory.

12. The mobile phone of claim 10, wherein said memory includes hybrid memory module.

13. The mobile phone of claim 12, wherein said memory includes NAND and NOR memory.

14. The mobile phone of claim 10, wherein said memory includes a sharing mode.
